(19) United States
(12) Patent Application Publication
(10) Pub. No.: US 2009/0098781 A1
(43) Pub. Date: Apr. 16, 2009

(54) Use of heavy-bodied lubricants in electrical connectors to eliminate intermittencies

(76) Inventor: Lou Volka, Holbrook, NY (US)

Correspondence Address: Thomas A. O'Rourke;Bodner & O'Rourke, Suite 108, 425 Broadhollow Road, Melville, NY, 11747, US

(21) Appl. No.: 12/283,284

(22) Filed: Sep. 10, 2008

Related U.S. Application Data
(60) Provisional application No. 60/993,305, filed on Sep. 11, 2007.

(51) Int. Cl. H01R 13/02

(52) U.S. Cl. 439/886

(57) ABSTRACT

A female electrical connector is provided having one or more recesses for receiving a male electrical connector. One or more of the recesses are provided with a heavy bodied lubricant. The heavy bodied lubricant is preferably a poly alpha olefin. The lubricant preferably has a penetration range of about 265 to 295 at a temperature of from −55° C. to 71° C.

This application claims priority on U.S. Provisional Patent Application Ser. No. 60/993,305, filed Sep. 11, 2007, the disclosures of which are incorporated herein by reference.

### FIELD OF INVENTION

This invention relates to electrical connectors and particularly to methods and materials which may be utilized to enhance the electrical and mechanical characteristics of the connection.

### BACKGROUND OF INVENTION

Electrical connectors are extensively used in machinery, in automotive and aerospace products, and many other applications. With increases in the number and complexity of electronic components, the wiring interfaces have evolved from single-point, soldered contacts to wire bundles terminating in multi-pin connectors. Development of multi-pin connectors required that sufficient force develop between the pin and socket to ensure adequate electrical conductivity. But to achieve this, a substantial compressive force was required to mate the male and female connectors. The extent of this compressive force created human factors issues with regard to the difficulty of repeated assembly-line installation of the connectors, and the potential for development of carpal tunnel syndrome.

Lubricants were considered to reduce frictional forces during insertion and extraction of high contact count connectors. Lubrication was also considered a viable approach to extending the operating life of a connector by preventing intermittent faults and electrical failure through a reduction in the harmful effects of contact fretting. Problems with fretting became more pronounced with the cost savings replacement of gold-plating with tin-lead solder plate. Lastly, lubrication protected against degradation due to corrosion at the pin/socket interface.

In the 1980's, Polytetrafluoroethylene (PTFE) was developed and utilized, but repeated coupling and uncoupling of the connector, on the order of eight or nine times, would burnish the PTFE into the surface of the contact, which created a layer of insulation where current would normally flow. Urea replaced PTFE to eliminate the problem of burnishing from multiple disconnect operations. Synthetic Hydrocarbons and Ethers tend to now dominate the market.

Despite the continued development of film lubricants and extensive development of various other protective materials used to coat or plate electrical connections, they as yet only provide a low level of protection against contamination and fretting, and are even less beneficial in the severe vibration environment. Under such adverse conditions of severe vibration, the connector contacts can resonate in a manner that produces intermittency of the electrical connection. While the duration of such intermittencies may be very small, on the order of nanoseconds or less, such disruptions can adversely affect high speed signals found in today's high tech electrical and communication circuits. This problem has been solved by this invention through a unique means of lubricating multi-pin electrical sockets.

### DESCRIPTION OF THE PRIOR ART

There is a multitude of existing patents that describe different approaches to improving the electrical qualities of connectors through various coatings. A 1981 U.S. Pat. No. 4,268,568 prescribes a fluorocarbon film as a lubricant for electrical connectors. U.S. Pat. No. 5,028,492 describes a composite coating containing a ductile metal matrix and a uniformly dispersed polymer component which offers lower friction coefficients and improved fretting corrosion resistance. U.S. Pat. No. 5,316,507 suggests a noble metal component and a solid phase lubricant component. U.S. Pat. No. 5,679,471 proposes a thin film silver-nickel coating, while U.S. Pat. Nos. 5,849,424 and 5,916,695 offer different versions of a tin coating, and U.S. Pat. No. 6,007,390 offers a composite coating of titanium nitride. U.S. Pat. No. 5,967,860 put forward an ultra-fine grain electrically deposited silver-nickel-carbon coating. While certainly not the only other remaining concept, U.S. Pat. No. 6,923,692, entitled “Electrical Connectors Incorporating Low Friction Coatings and Methods for Making Them” advances the idea of utilizing a composite coating of molybdenum disulfide and a metal, preferably tin, for one or both of the contact surfaces.

Unfortunately, none of these coatings solves the difficulties encountered in the severe vibration environment. But this intractable problem that is solved by applications of a heavy bodied lubricant to the connector as described herein.

### BRIEF SUMMARY OF THE INVENTION

The present invention is directed to male and female electrical connectors where each and every receptacle of the female connector is completely filled with a suitable heavy-bodied lubricant, thereby creating a dense medium around the receptacle contacts. Once the male and female connectors are mated, this dense medium provides a damping action to environment induced vibrations that can be transmitted to all or some of the contacts and cause a resonance condition. The resonance condition would otherwise cause the receptacle contacts to intermittently break the conductive path between mating contact elements. The resonance condition also causes an acceleration of contact corrosion.

Additionally, this application of a heavy bodied lubricant serves as an environmental seal by surrounding the mated contacts of the connector, thereby excluding the corrosive agents from attacking the contact finishes. Use of the heavy-bodied lubricant in this manner will thus enhance connector performance and longevity in salt atmospheres.

This invention has been shown to be effective not only in new, unused connectors, but has demonstrated the ability to “repair” connectors that have already exhibited intermittencies and fretting damage in service.

### BRIEF DESCRIPTION OF THE DRAWINGS

FIG. 1 shows, merely to be illustrative, one particular style of female electrical connector with multiple receptacles that would be filled with the heavy bodied lubricant.

FIG. 2 shows an example of another type of electrical connection useful with the invention.

### DETAILED DESCRIPTION OF THE PREFERRED EMBODIMENTS

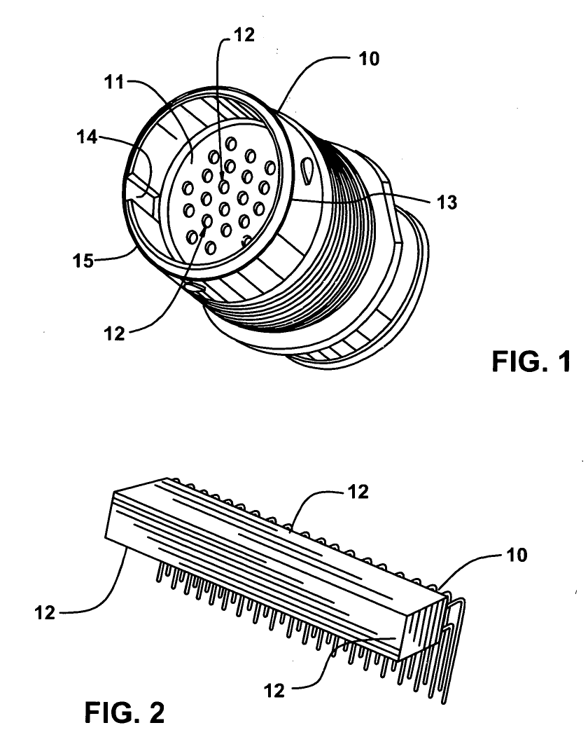

The present invention is directed to utilization of heavy-bodied lubricants to be used in conjunction with electrical connectors. By the term heavy bodied is meant a lubricant that does not readily flow at normal operating temperatures for the electrical connector of the present invention. This process may be utilized for electrical connectors of various shapes and sizes, and is not limited to the example used herein. It should be noted that female connectors commonly have a pocketed area within which a plurality of small openings or receptacles may exist. The number of receptacles shall normally match the number of pin contacts of the mating male connector, which is designed to satisfy the requirements of the associated electrical components. For the connector used as an example in FIG. 1, when the male connector is mated to the female connector, alignment of the pins of the male socket is generally obtained by clocking the connectors for a key-like protrusion on the male connector to align with a slot or slots 11 in the pocketed area of the female connector. For other styles of electrical connectors, for example those used to connect a monitor to a desktop computer, the shape of the connector ordinarily dictates one unique orientation at which mating can occur.

In a preferred embodiment of the invention, using for example the style of a female connector 10 shown in FIG. 1. As shown in FIG. 1, there is a representative female connector 10. The connector has a base 11 with a plurality of recesses 12 for receiving pins from a male connector, not shown. Extending from the base 11 may be one or more sidewalls 13 that extend upwardly from the base to form a pocket or recessed area. The sidewalls have an interior and an exterior surface. There may be one or more slots 14 that extend from the top surface 15 of the sidewall toward the base. These slots are adapted to receive a key on the male connector. In one embodiment, the slot may be on an interior surface of the sidewall and the key on an exterior surface of a male member that fits within the sidewalls of the female connector. Alternatively, the key may be on the sidewall 13 and the recess on the exterior surface of the male member. The key and slot permit proper alignment of the male and female connectors so that the pins on the male member mate with the recesses in the base of the female member.

In an alternative embodiment, the male member with the pins has an interior base with one or more pins extending therefrom which are adapted to be received by an appropriate recess in a female member. The male member in this embodiment may extend over the outer surface of the sidewalls of the female member. In that embodiment the interior sidewall of the male member may have a key that mates with a recessed slot on the outer surface of the female member. Alternatively, the key can be on the outer surface of the female member and the slot on the inner surface of the male member.

FIG. 2 shows an alternative embodiment of a female connector. It will be appreciated that there may be a myriad of different types of female connectors. In each instance however, there will be a recess for receiving the pin of a male connector where an electrical connection will be formed. It is these recesses that will receive the lubricant in accordance with the present invention. The sidewalls of the female member form a receptacle for receiving the lubricant. The heavy-bodied lubricant is applied in a fashion that completely fills all of the recesses 12 of a female connector 10. This includes the recesses that receive the pins on the male member as well as the pocket or recesses area formed by the sidewalls of the female member. Similarly, if the male member has sidewalls extending out from the base where the pins extend, the lubricant can be placed therein as well.

The female connector receives a male connector and one or more pins of the male connector are in electrical contact with recessed electrical contacts of the female connector. Prior to connecting the male and female connectors, the recesses of the female connector receive the heavy bodied lubricant. When the male connectors are in electrical contact with the female connectors the male and female connectors do not produce intermittency of the electrical connection when vibrated due to the presence of the heavy bodied lubricant. Once the male and female connectors are in electrical contact the presence of the heavy bodied lubricant prevents the male and female connectors from producing resonance that breaks a conductive path when said connectors are vibrated.

Lubricant may be inserted, for example, by any suitable means so as to completely fill every receptacle. One method is to manually apply the lubricant with a tool such as a spatula or other device. The lubricant is non-conductive and functions primarily as a damping agent. The lubricant lowers friction and creates a seal. The lubricant must be heavy-bodied, having a penetration in the range of about 265 to 295 at from about −55° C. to 71° C. ASTM D217 and D1403 which are incorporated herein by reference measure the penetration of worked and unworked greases. To measure penetration, a cone of a given weight is allowed to sink into a grease for 5 seconds at a standard temperature of 25° C. The depth in tenths of a millimeter, to which the cone sinks into the grease is the penetration.

The preferred lubricant is a poly alpha olefin (PAO). Other natural and synthetic lubricants having the desired penetration can be used.

Once each and every receptacle has been filled with heavy-bodied lubricant, the female connector shown may be mated with the male connector, or be covered with a protective cap and allowed to stand in that condition or be stored for later assembly. The connector does not need to have a uniquely configured shape or a special casing material for the damping effect to occur. The process is preferably repeated for every decoupling and re-coupling of the connector pair.

I claim:

1. A female connector, said female connector having one or more recesses for receiving a male member, said recess forming an opening in said female connector, said recess having a heavy bodied lubricant present in one or more of said recesses.

2. The female connector according to claim 1 wherein each of said recesses has a heavy bodied lubricant therein.

3. The female connector according to claim 2 wherein said heavy bodied lubricant is non-conductive.

4. The female connector according to claim 3 wherein said heavy bodied lubricant has a penetration in the range of about 265 to 295 at from about −55° C. to 71° C.

5. The female connector according to claim 4 wherein the heavy bodied lubricant is a polyalpha olefin (PAO).

6. The female connector according to claim 5 wherein said base has extending upwardly therefrom one or more sidewalls.

7. The female connector according to claim 6 wherein said sidewall forms a pocket opened at one end thereof.

8. The female connector according to claim 7 wherein said pocket has a heavy bodied lubricant in said recesses.

9. The female connector according to claim 8 wherein said pocket has a cap over said open end.

10. The female connector according to claim 5 wherein said connector has a cap over said recesses.

11. The female connector according to claim 5 wherein one or more of said recesses containing said poly alpha olefin have received pins from a male connector.

12. The female connector according to claim 8 wherein said sidewall has a key that is adapted to mate with a key on a male member.

13. The female connector according to claim 1 wherein said connector is adapted to receive a multi pin male connector in its recesses.

14. The female connector according to claim 4 wherein said female connector receives a male connector and one or more pins of the male connector are in electrical contact with recessed electrical contacts of said female connector and wherein said male and female connectors do not produce intermittency of the electrical connection when vibrated.

15. The female connector according to claim 4 wherein said connector receives a male connector and the pins of the male connector are in electrical contact with recessed electrical contacts of said female connector and wherein said male and female connectors do not produce resonance that breaks a conductive path when said connectors are vibrated.
